(19) United States
(12) Patent Application Publication
(10) Pub. No.: US 2008/0030506 A1
(43) Pub. Date: Feb. 7, 2008

(54) Video card and the sound processing module therein

(75) Inventors: Chih-Peng Wu, Taipei City (TW); Kuo-Hsun Huang, Taipei City (TW); Chien-Jung Chen, Taipei City (TW)

Correspondence Address: BACON & THOMAS, PLLC, 625 SLATERS LANE, FOURTH FLOOR, ALEXANDRIA, VA, 22314, US

(73) Assignee: ASUSTEK COMPUTER INC., Taipei City (TW)

(21) Appl. No.: 11/882,478

(22) Filed: Aug. 2, 2007

(30) Foreign Application Priority Data
Aug. 3, 2006 (TW) 095128489

(51) Int. Cl. G06F 15/00; G06F 17/00

(52) U.S. Cl. 345/501; 700/94

(57) ABSTRACT

The invention relates to a video card, an audio-video card, and an audio processing card, in which a digital signal processing unit performs a sound processing on a raw sound signal to thereby output a digital sound signal. Besides, a high quality multimedia interface transmission unit receives the digital sound signal and a video signal to thereby output a high quality multimedia signal. Accordingly, the central processing unit (CPU) load is reduced, and the high quality sound effects are provided.

### BACKGROUND OF THE INVENTION

1. Field of the Invention

The present invention relates to a video card, an audio-video card, and an audio processing card and, more particularly, to a video card, an audio-video card, and an audio processing card that are suitable for digital audio-video processing.

2. Description of Related Art

In current home audiovisual equipment, personal computers (PCs) and portable audio-video (AV) players, the audio-video processing technologies essentially focus on the digital signal processing for a video signal while a raw sound signal is simply processed.

The principle of an audio-video processing technology is described as follows. If a PC is given as an example, a CPU on the motherboard performs a sound processing on the raw sound signal, and a video card is implemented to process the video signal in order to obtain a preferable quality frame. After the video card typically receives a video signal from the motherboard and the sound signal processed by the CPU, an AV processing chip thereon performs a digital to analog conversion on the video signal and a signal analysis only, and subsequently outputs the video and the sound signals respectively to a video and an audio input ports of a home audiovisual equipment, PC or portable AV player.

Accordingly, the typical digital processing for the sound signal is based on the CPU on the motherboard, which increases the CPU load. In order to overcome this, the procedure of using the CPU to process the sound signal is simplified. However, such a way also reduces the sound quality with the limited CPU load reduction.

### SUMMARY OF THE INVENTION

An object of the present invention is to provide a video card, an audio-video card and an audio processing card, which can reduce the CPU load.

Another object of the present invention is to provide a video card, an audio-video card, and an audio processing card, which can enhance the high quality sound.

According to a feature of the invention, a video card is provided, including: a digital signal processing unit to receive a digital raw sound signal and at least output a digital sound signal; and a high quality multimedia interface transmission unit electrically connected to the digital signal processing unit in order to receive the digital sound signal and a video signal to thereby output a high quality multimedia signal.

According to another feature of the invention, an audio-video card is provided, including: a daughter card, which has a digital signal processing unit to receive a digital raw sound signal and to at least output a digital sound signal; and a display card, which has a high quality multimedia interface transmission unit electrically connected to the digital signal processing unit in order to receive the digital sound signal and a video signal to thereby output a high quality multimedia signal.

According to a further feature of the invention, an audio processing card is provided. The audio processing card electrically connected to a display card includes a digital signal processing unit to receive a digital raw sound signal and at least output a digital sound signal. The digital sound signal and a video signal are received by the display card, thereby outputting a high quality multimedia signal.

Other objects, advantages, and novel features of the invention will become more apparent from the following detailed description when taken in conjunction with the accompanying drawings.

### BRIEF DESCRIPTION OF THE DRAWINGS

FIG. 1 is a functional block diagram of a video card according to an embodiment of the invention;

FIG. 2 shows a functional block diagram of an audio-video card according to another embodiment of the invention; and

FIG. 3 is a schematic diagram of connection of a daughter card and a mother card according to an embodiment of the invention.

### DETAILED DESCRIPTION OF THE PREFERRED EMBODIMENT

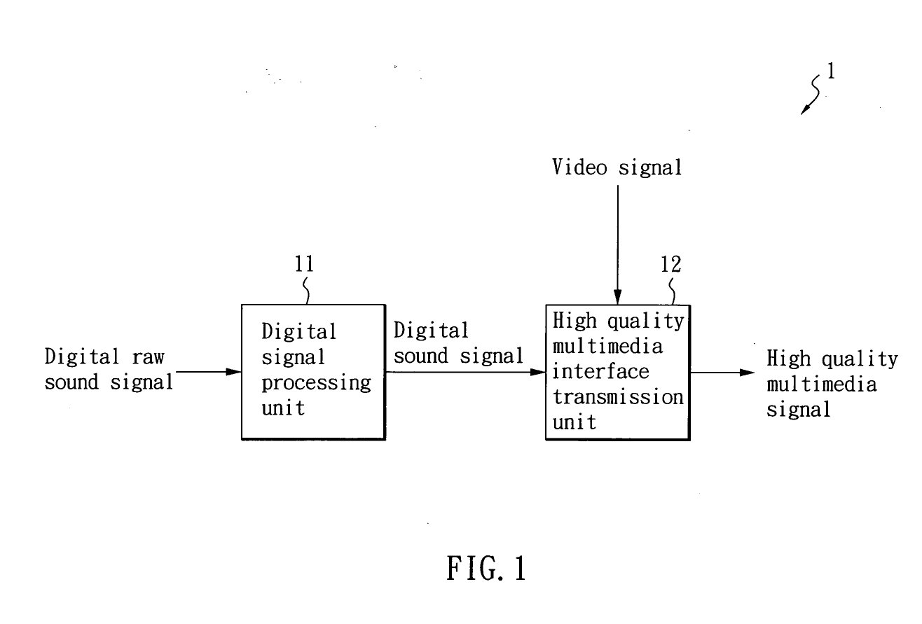

FIG. 1 is a functional block diagram of a video card according to an embodiment of the invention.

As shown in FIG. 1, the video card 1 includes a digital signal processing unit 11 and a high quality multimedia interface transmission unit 12. The digital signal processing unit 11 is electrically connected to the high quality multimedia interface transmission unit 12.

The digital signal processing unit 11 receives a digital saw sound signal and performs a digital sound processing on the digital saw sound signal to thereby output a digital sound signal. In this embodiment, the digital saw sound signal is received from a motherboard, but in other embodiments, it can be received from a sound receiver or a sound source transmission line. The digital signal processing unit 11 codes and compresses the intensity and frequency of the digital raw sound signal to thereby obtain a multi-channel signal with a 5.1 channel, 7.1 channel or interface format compatible with the Sony/Philip Digital Interface Input Unit (SPDIF).

The 5.1-channel coding format includes the Dolby Digital AC-3, the Dolby Surround AC-3, the Digital Theater Systems (DTS), and/or the Home THX Audio System. The 7.1-channel coding format includes the DVD-Video, and/or Sony Dynamic Digital Sound (SDDS).

An embodied aspect of the high quality multimedia interface transmission unit 12 is a transmission channel supporting a high-definition multimedia interface (HDMI), which provides the output of a high quality multimedia signal. The high quality multimedia interface transmission unit 12 receives the digital sound signal from the digital signal processing unit 11 and outputs the digital sound signal and a video signal to thereby output the high quality multimedia signal. The video signal is an image signal after the picture analysis, display color operations or signal format conversion.

In this embodiment, the video card 1 is connected with a PC (not shown) through the high quality multimedia interface transmission unit 12 in order to output the high quality multimedia signal to the PC for a playback. In other embodiments, the high quality multimedia interface transmission unit 12 can be connected to an LCD or low temperature polysilicon thin film transistor LCD (LTPS-TFT LCD), CRT, plasma display or projector.

Accordingly, the digital sound signal is obtained by using the digital signal processing unit 11 to perform a sound processing on the digital raw sound signal, which relatively reduces the CPU load and provides a high quality sound.

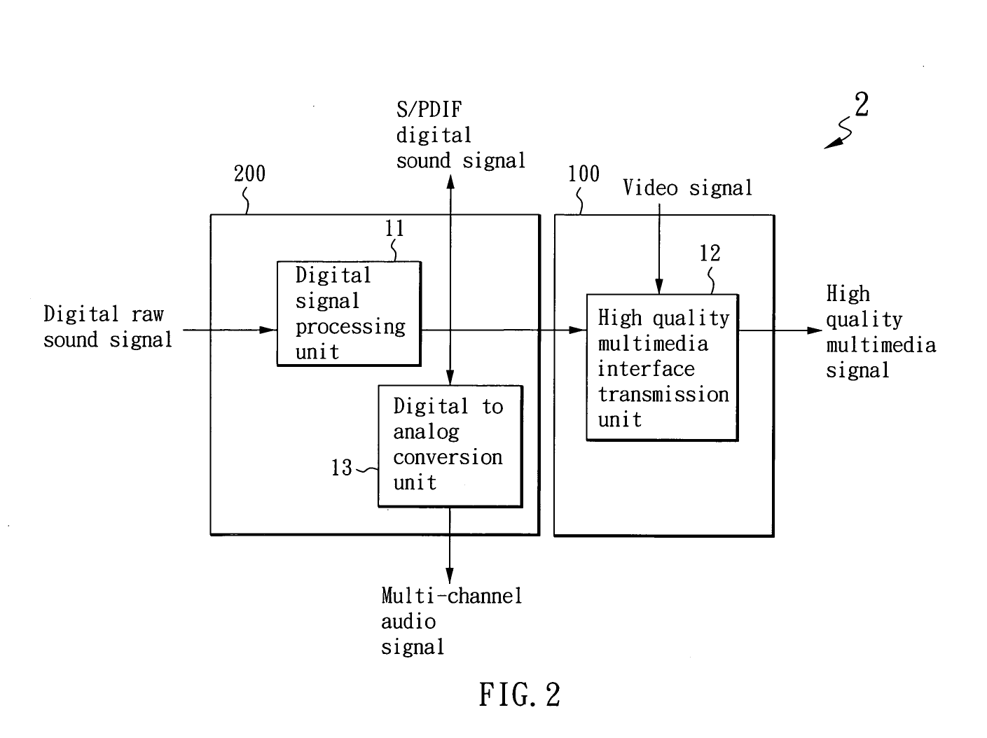

FIG. 2 shows a functional block diagram of an audio-video card according to another embodiment of the invention.

As shown in FIG. 2, the audio-video card includes a digital signal processing unit 11, a high quality multimedia interface transmission unit 12 and a digital to analog conversion unit 13. The digital signal processing unit 11 is connected to the high quality multimedia interface transmission unit 12 and the digital to analog conversion unit 13. The digital signal processing unit 11 and the digital to analog conversion unit 13 are implemented on a daughter card 200 while the high quality multimedia interface transmission unit 12 is implemented on a mother card 100.

An embodied aspect of the mother card 100 can be a video card or a video graphic array card (VGA card), and an embodied aspect of the daughter card 200 can be an audio processing card.

The mother card 100 can include a plurality of accelerated graphics port (AGP) pins (not shown) or PCI-E pins (not shown). The AGP pins are electrically connected to the AGP extensive slot (not shown) on the motherboard and the high quality multimedia interface transmission unit 12. The PCI-E pins are electrically connected to the PCI-E extensive slot (not shown) on the motherboard and the high quality multimedia interface transmission unit 12. Accordingly, a video signal is transmitted to the high quality multimedia interface transmission unit 12.

In this embodiment, the digital signal processing unit 11 uses a coaxial cable or an optical fiber to receive the digital raw sound signal via the Sony/Philip Digital Interface. In other embodiments, the digital raw sound signal can be sent to the digital signal processing unit 11 via a peripheral component interconnect (PCI) or universal serial bus (USB).

The units 11 and 12 of FIGS. 1 and 2 are the same except that in this embodiment the digital sound signal with 5.1 channel, 7.1 channel or Sony/Philip Digital Interface format processed by the digital signal processing unit 11 can be sent to a speaker (not shown) via the coaxial cable or optical fiber for a sound playback, in addition that the unit 12 receives the digital sound signal and outputs a high quality multimedia signal.

Further, the digital sound signal with 5.1 channel, 7.1 channel or Sony/Philip Digital Interface format can be converted into an analog sound signal by the digital to analog conversion unit 13, and the channels for the analog sound signal are provided to the speaker for decoding and playing the sound.

In this embodiment, the speaker is a speakerphone. In other embodiment, the speaker can be loudspeaker or earphone.

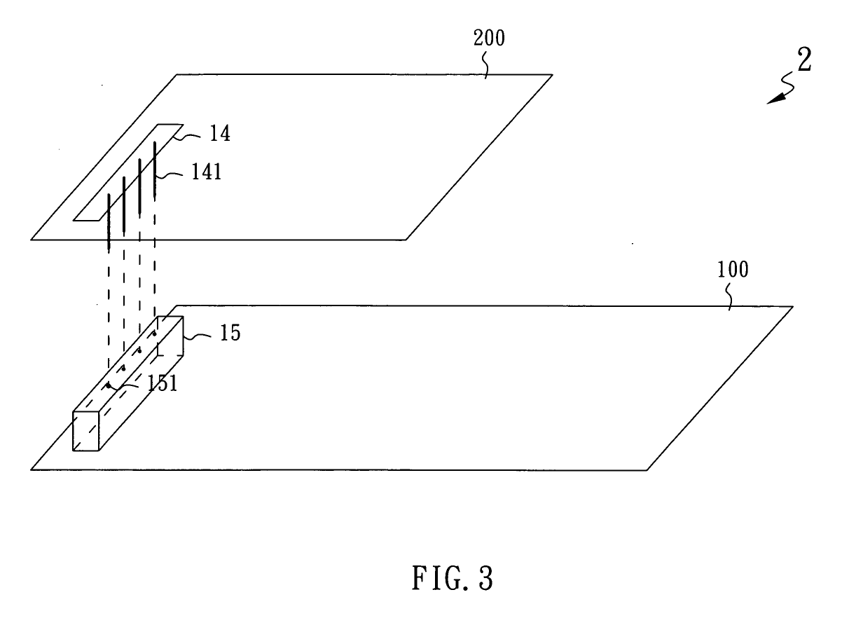

FIG. 3 is a schematic diagram of connection of a daughter card and a mother card according to an embodiment of the invention. In this embodiment, the digital signal processing unit 11 is electrically connected with the high quality multimedia interface transmission unit 12 through a pair of connectors 14, 15. The connectors 14, 15 are electrically connected to the digital signal processing unit 11 and the high quality multimedia interface transmission unit 12 respectively. The connectors 14, 15 are implemented on the daughter card 200 and the mother card 100 respectively.

The connector 14 on the daughter card 200 has a plurality of pins 141 for electrically connecting to the connector 15 on the mother card 100. Thus, the phase and voltage of the digital sound signal are sent to the connector 15 through the pins 141.

The connector 15 has a plurality of pinholes 151 corresponding to the pins 141 of the connector 14 on the daughter card 200 for receiving in a one to one manner and electrically connecting to the connector 14. Thus, the signal processing unit 11 can output the digital sound signal to the high quality multimedia interface transmission unit 12.

In another preferred embodiment of the invention, a power input unit can be implemented on the mother and the daughter cards in order to electrically connect to an input power source between an external power supply (not shown) and the high quality multimedia interface transmission unit 12 or the digital signal processing unit 11 and accordingly power the units on the mother and the daughter cards for maintaining the operations in normal.

In another preferred embodiment of the invention, a storage unit (not shown) can be implemented on the mother and the daughter cards and is electrically connected to the high quality multimedia interface transmission unit 12 or the digital signal processing unit 11. The storage unit can be a SDRAM, EDO DRAM or SGRAM for storing the high quality multimedia signal, video signal, digital sound signal, multi-channel signal or digital raw sound signal.

In another preferred embodiment of the invention, an image processing unit (not shown) electrically connected to the high quality multimedia interface transmission unit 12 is implemented on the mother card in order to receive an image signal for performing a picture analysis or format conversion and to output the processed image signal to the high quality multimedia interface transmission unit 12. Subsequently, the high quality multimedia interface transmission unit 12 receives the processed image signal output by the image processing unit and the digital sound signal output by the digital signal processing unit 11 to thereby output a high quality multimedia signal.

As cited, the video card, the audio-video card, the audio processing card of the invention uses the digital signal processing unit to perform a sound processing on the digital raw sound signal to thereby output a digital sound signal, and uses the high quality multimedia interface transmission unit to receive the digital sound signal and a video signal to thereby output a high quality multimedia signal. Accordingly, the CPU load is reduced and the high quality sound is provided.

Although the present invention has been explained in relation to its preferred embodiment, it is to be understood that many other possible modifications and variations can be made without departing from the spirit and scope of the invention as hereinafter claimed.

What is claimed is:

1. A video card, comprising:
a digital signal processing unit, which receives a digital raw sound signal and at least output a digital sound signal; and
a high quality multimedia interface transmission unit, which is electrically connected to the digital signal processing unit in order to receive the digital sound signal and a video signal to thereby output a high quality multimedia signal.

2. The video card as claimed in claim 1, wherein the high quality multimedia interface transmission unit supports a high-definition multimedia interface (HDMI).

3. The video card as claimed in claim 1, wherein the digital sound signal is a sound signal with a 7.1-channel, 5.1-channel or Sony/Philip Digital Interface format.

4. The video card as claimed in claim 1, wherein the digital raw sound signal is a raw sound signal with a Sony/Philip Digital Interface format.

5. The video card as claimed in claim 1, further comprising a digital to analog conversion unit, which is electrically connected to the digital signal processing unit in order to convert the digital sound signal into an analog sound signal.

6. The video card as claimed in claim 1, wherein the high quality multimedia interface transmission unit is implemented on a mother card, and the digital signal processing unit is implemented on a daughter card.

7. The video card as claimed in claim 6, wherein the mother card and the daughter card has a connector respectively, where the connector on the mother card is electrically connected to the high quality multimedia interface transmission unit, the connector on the daughter card is electrically connected to the digital signal processing unit, and the connectors on the mother card and the daughter card are electrically connected to accordingly electrically connect the digital signal processing unit with the high quality multimedia interface transmission unit.

8. The video card as claimed in claim 6, wherein the connector on the daughter card comprises a plurality of pins, and the connector on the mother card comprises a plurality of pinholes corresponding to the pins, in a one-to-one manner.

9. An audio-video card, comprising:
a daughter card, which has a digital signal processing unit to receive a digital raw sound signal and to at least output a digital sound signal; and
a display card, which has a high quality multimedia interface transmission unit electrically connected to the digital signal processing unit in order to receive the digital sound signal and a video signal to thereby output a high quality multimedia signal.

10. The audio-video card as claimed in claim 9, wherein the high quality multimedia interface transmission unit supports a high-definition multimedia interface (HDMI).

11. The audio-video card as claimed in claim 9, wherein the digital sound signal is a sound signal with a 7.1-channel, 5.1-channel or Sony/Philip Digital Interface format.

12. The audio-video card as claimed in claim 9, wherein the digital raw sound signal is a raw sound signal with a Sony/Philip Digital Interface format.

13. The audio-video card as claimed in claim 9, further comprising a digital to analog conversion unit, which is electrically connected to the digital signal processing unit in order to convert the digital sound signal into an analog sound signal.

14. The audio-video card as claimed in claim 9, wherein the display card and the daughter card comprises a connector respectively, where the connector on the display card is electrically connected to the high quality multimedia interface transmission unit, the connector on the daughter card is electrically connected to the digital signal processing unit, and the connectors on the mother card and the daughter card are electrically connected to accordingly electrically connect the digital signal processing unit with the high quality multimedia interface transmission unit.

15. The audio-video card as claimed in claim 9, wherein the connector on the daughter card comprises a plurality of pins, and the connector on the display card comprises a plurality of pinholes corresponding to the pins, in a one-to-one manner.

16. An audio processing card electrically connected to a display card, comprising:
a digital signal processing unit, which receives a digital raw sound signal and at least output a digital sound signal, wherein the digital sound signal and a video signal are received by the display card to thereby output a high quality multimedia signal.

17. The audio processing card as claimed in claim 16, wherein the high quality multimedia interface transmission unit supports a high-definition multimedia interface (HDMI).

18. The audio processing card as claimed in claim 16, wherein the digital sound signal is a sound signal with a 7.1-channel, 5.1-channel or Sony/Philip Digital Interface format.

19. The audio processing card as claimed in claim 16, wherein the digital raw sound signal is a raw sound signal with a Sony/Philip Digital Interface format.

20. The audio processing card as claimed in claim 16, further comprising a digital to analog conversion unit, which is electrically connected to the digital signal processing unit in order to convert the digital sound signal into an analog sound signal.
